(19) United States
(12) Patent Application Publication
(10) Pub. No.: US 2020/0343548 A1
(43) Pub. Date: Oct. 29, 2020

(54) ELECTRODE COMPOSITION AND PREPARATION PROCESS FOR LITHIUM-ION BATTERY, ELECTRODE AND BATTERY INCORPORATING SAME

(71) Applicant: HUTCHINSON, Paris (FR)

(72) Inventors: Bruno DUFOUR, Champagne sur Seine (FR); Marc ZIMMERMANN, Achenheim (FR); Ksenia ASTAFYEVA, Montargis (FR); Julie COURTAT, Pannes (FR); Capucine DOUSSET, Montargis (FR)

(73) Assignee: HUTCHINSON, Paris (FR)

(21) Appl. No.: 16/754,276

(22) PCT Filed: Oct. 8, 2018
(86) PCT No.: PCT/FR2018/052482

§ 371 Date: Apr. 7, 2020

(30) Foreign Application Priority Data
Oct. 9, 2017 (FR) 17 59446

(51) Int. Cl. H01M 4/525; H01M 10/0525; H01M 4/505; H01M 4/62; H01M 4/583; H01M 10/44; H01M 4/36; H01M 4/66

(52) U.S. Cl. CPC H01M 4/525; H01M 10/0525; H01M 4/505; H01M 4/661; H01M 4/583; H01M 10/44; H01M 4/364; H01M 4/622

(57) ABSTRACT

The invention relates to an electrode composition for lithium-ion battery, a process for preparing the composition, such an electrode and a lithium-ion battery incorporating same. The composition comprises an active substance able to perform reversible insertion/deinsertion of lithium in the electrode, an electrically conductive filler and a polymeric binder comprising at least one modified polyolefin, and it is such that the modified polyolefin (If1) is derived from a nonpolar aliphatic polyolefin and incorporates oxygenated CO and OH groups, having a content by weight of oxygen atoms of between 2% and 10% inclusive. The modified polyolefin may be the product of a controlled thermal oxidation reaction, under an atmosphere comprising oxygen and at a temperature of between 200° C. and 300° C., of the nonpolar aliphatic polyolefin with oxygen.

The present invention relates to an electrode composition which is usable in a lithium-ion battery, to a process for preparing this composition, to such an electrode and to a lithium-ion battery of which the or each cell incorporates this electrode.

Two main kinds of lithium accumulator batteries exist: lithium metal batteries, in which the negative electrode is composed of lithium metal (material which poses safety problems in the presence of a liquid electrolyte), and lithium-ion batteries, in which the lithium remains in ionic form.

Lithium-ion batteries consist of at least two conductive faradic electrodes of different polarities, the negative electrode or anode and the positive electrode or cathode, between which electrodes is a separator which constitutes an electrical insulator soaked in an aprotic electrolyte based on Li⁺ cations which ensures the ion conductivity. The electrolytes used in these lithium-ion batteries usually consist of a lithium salt, for example of formula LiPF₆, LiAsF₆, LiCF₃SO₃ or LiClO₄, which is dissolved in a mixture of nonaqueous solvents such as acetonitrile, tetrahydrofuran or, usually, a carbonate, for example ethylene or propylene carbonate.

A lithium-ion battery is based on the reversible exchange of the lithium ion between the anode and the cathode during the charging and discharging of the battery, and it has a high energy density for a very low mass by virtue of the physical properties of lithium.

The active material of the anode of a lithium-ion battery is designed to be the site of reversible insertion/deinsertion of lithium and is typically formed from graphite (theoretical capacity of 370 mAh/g and redox potential of 0.05 V, relative to the Li⁺/Li couple) or as a variant mixed metal oxides, among which are included lithium titanium oxides of formula Li₄Ti₅O₁₂, for example. As regards the active material of the cathode, it is usually formed from a transition metal oxide or a lithium iron phosphate. These active materials thus allow reversible insertion/deinsertion of lithium into electrodes, and the higher their mass fractions, the greater the capacity of the electrodes.

These electrodes must also contain an electrically conductive compound, such as carbon black, and, to give them sufficient mechanical cohesion, a polymeric binder.

Lithium-ion battery electrodes are usually manufactured via a liquid-route process successively comprising a step of dissolving or dispersing the ingredients of the electrode in a solvent, a step of spreading the solution or dispersion obtained on a metallic current collector, and then finally a step of evaporating off the solvent. Processes using an organic solvent (such as the one presented in US-A1-2010/0 112 441) have drawbacks in the fields of the environment and safety, in particular due to the fact that it is necessary to evaporate large amounts of these solvents which are toxic or flammable. As regards processes using an aqueous solvent, their major drawback is the fact that the electrode must be dried very thoroughly before being able to be used, traces of water limiting the useful service life of the lithium batteries. Mention may be made, for example, of EP-B1-1 489 673 for the description of a process for manufacturing an anode based on graphite and on an elastomeric binder and using an aqueous solvent.

It has thus been sought in the past to manufacture electrodes for lithium-ion batteries without using solvents, notably via melt-route implementation techniques (for example by extrusion). Unfortunately, these melt-route processes give rise to major difficulties in the case of these batteries which require a mass fraction of active material in the polymer blend of the anode of greater than 85% so that said anode has a sufficient capacity within the battery. Now, at such contents of active material, the viscosity of the mixture becomes very high and entails risks of overheating of the mixture and of loss of mechanical cohesion after its implementation. U.S. Pat. No. 5,749,927 presents a process for the continuous preparation by extrusion of lithium-polymer battery electrodes, which comprises mixing of the electrode active material with an electrical conductor and a solid electrolyte composition comprising a polymeric binder such as a polyacrylonitrile (PAN), a polyvinylidene difluoride (PVDF) or polyvinylpyrrolidone (PVP), a lithium salt and a propylene carbonate/ethylene carbonate mixture in large excess relative to this polymer. In said document, the mass fraction of active material present in the anode polymeric composition obtained is less than 70%, which is markedly insufficient for a lithium-ion battery.

WO-A1-2013/090487 teaches in its exemplary embodiments of using a polar aliphatic polyolefin consisting of polyvinylidene fluoride (PVDF) as binder in a process that is substantially solvent-free for preparing a lithium-ion battery cathode composition by depositing the cathode composition onto a collector by friction. Said document mentions, in addition to such a fluorinated polyolefin such as PVDF or a tetrafluoroethylene polymer, the possible use of unmodified polyolefins such as those prepared from ethylene, propylene or butylene.

U.S. Pat. No. B2-6,939,383 teaches the use, as a binder, in a lithium-ion battery electrode composition prepared without solvent in a multi-screw extruder, of an ionically conductive polyether comprising a polar polymer of an alkene oxide such as an ethylene oxide-propylene oxide-allyl glycidyl ether copolymer, optionally combined with an ionically nonconductive polymer such as a PVDF, a PAN, PVP, an ethylene-propylene-diene terpolymer (EPDM) or a styrene-butadiene copolymer (SBR) prepared in emulsion. In the sole exemplary embodiment of said document, the mass fraction of active material present in the electrode composition is only 64.5%, which is markedly insufficient for a lithium-ion battery.

U.S. Pat. No. B1-7,820,328 teaches the use of a thermoplastic polymer as binder in a lithium-ion battery electrode composition prepared via the wet or dry route with thermal decomposition of a sacrificial polymer such as ethyl cellulose, an acrylic resin, a polyvinyl alcohol, a polyvinyl butyral or a polyalkene carbonate. This decomposition is performed under an inert atmosphere (i.e. a nonoxidative atmosphere, for example under argon) for an anode composition and under an atmosphere that is either inert or oxidative (e.g. in air) for a cathode composition. Said document does not contain any examples of preparing an anode or cathode composition with a given active material and a given binder, only indicating that the decomposition conditions of the sacrificial polymer under inert or oxidative atmosphere are rigorously controlled so as not to degrade the other ingredients of the composition such as the binder which is thus not modified and may be chosen from polyethylenes, polypropylenes and fluorinated polyolefins such as PVDF or PTFE.

EP-B1-2 639 860 in the name of the Applicant teaches the melt-route preparation without solvent evaporation of a lithium-ion battery anode composition comprising more than 85% by mass of active material, a polymeric binder formed from a crosslinked diene elastomer such as a hydrogenated nitrile rubber (HNBR), and a nonvolatile organic compound that is usable in the electrolyte solvent of the battery.

WO-A2-2015/124 835, also in the name of the Applicant, presents a lithium-ion battery electrode composition prepared via a melt route and without solvent evaporation, using a sacrificial polymer phase which is mixed with an active material, with a polymeric binder chosen to be compatible with this phase and with a conductive filler to obtain a precursor mixture, followed by elimination to obtain improved plasticization and fluidity during the implementation of the molten mixture, despite a mass fraction of active material usable in the composition of greater than 80%. Said document recommends in its exemplary embodiments using a binder derived from a polar elastomer which is an HNBR or an ethylene-ethyl acrylate copolymer for its compatibility with the sacrificial phase, which is itself also polar and is a polyalkene carbonate, to avoid phase macroseparation following the mixing of the ingredients and to control the implementation, integrity and porosity of the composition obtained by heat treatment in a furnace under air of the precursor mixture to decompose the sacrificial phase. Said document mentions as a variant the possible use of other binder-forming polymers, with the proviso that they are compatible with the chosen sacrificial phase, so that said phase is continuous in the precursor mixture in which the binder is found in dispersed or cocontinuous phase, these other polymers possibly being chosen from polyolefins in the broad sense and elastomers such as polyisoprenes. This compatibility constraint between binder and sacrificial phase thus imposes the use of a binder having a polarity similar to that of the sacrificial phase to avoid having two separate phases in the precursor mixture.

The electrode compositions presented in these last two documents are on the whole satisfactory for a lithium-ion battery; however, the Applicant has sought in the course of its recent research to further improve the electrochemical properties thereof and notably the reversibility thereof during the first charging-discharging cycle, their capacity notably at regimes of C/5 and C/2 and their degree of retention of capacity after 20 cycles.

One aim of the present invention is thus to propose a novel lithium-ion battery electrode composition containing an active material in more than 85% by mass, which is in particular suitable for melt-route implementation and without solvent without the chosen binder being compatible with the sacrificial phase, while at the same time being able to give the electrode increased reversibility on the first charging-discharging cycle, and a capacity and a cyclability (i.e. retention of the capacity after a plurality of cycles) which are both improved.

This aim is achieved in that the Applicant has just discovered, surprisingly, that if this active material and an electrically conductive filler are mixed with a modified polyolefin as polymeric binder which is derived from an apolar aliphatic polyolefin and which incorporates oxygenated groups CO and OH, having a mass content of oxygen atoms inclusively between 2% and 10%, then it is notably possible via the melt route and without solvent evaporation to obtain a lithium-ion battery electrode composition which has these improved electrochemical performance qualities while at the same time using a polar sacrificial polymeric phase, such as an alkene carbonate polymer, forming before its decomposition two separate phases with this binder.

Thus, the present invention goes against the teaching of the abovementioned document WO-A2-2015/124 835, due to the fact that it uses for the binder an apolar starting polymer which is incompatible with the polar sacrificial phase and also incompatible with the electrolyte, which is also polar, used for the battery, this starting polymer specifically being an apolar aliphatic polyolefin (i.e. excluding in the family of polyolefins aromatic polyolefins and polar polyolefins) and which is modified in a very specific and controlled manner in the composition obtained after elimination of the sacrificial phase, by addition of these oxygenated groups so that the modified polyolefin satisfies the abovementioned restricted range for its mass content of oxygen.

In other words, an electrode composition according to the invention is usable in a lithium-ion battery, the composition comprising an active material that is capable of performing reversible insertion/deinsertion of lithium in said electrode, an electrically conductive filler and a polymeric binder comprising at least one modified polyolefin, and this composition is such that said at least one modified polyolefin is derived from an apolar aliphatic polyolefin and incorporates CO and OH oxygenated groups, having a mass content of oxygen atoms inclusively between 2% and 10%.

It will be noted that these oxygenated groups coupled with this mass content of oxygen of from 2% to 10% (m/m content measured, for example, by elemental analysis) are reflected by the fact that said at least one modified polyolefin which is functionalized with these groups is more polar than the starting apolar aliphatic polyolefin, while at the same time remaining apolar overall (i.e. sparingly polar) by this functionalization, the content of which in the chain of the modified polyolefin is controlled so as to be sufficient (cf. mass content of oxygen of at least 2%) but not too high (cf. mass content of oxygen of not more than 10%) to obtain the targeted electrochemical properties including the reversibility on the first cycle, the capacity at a regime of C/5 and the cyclability of the electrode (i.e. its retention of capacity).

Specifically, the Applicant established during comparative tests that insufficient functionalization of the apolar aliphatic polyolefin (i.e. with said mass content less than 2% and, for example, zero, the apolar polyolefin not being modified in this case) or excessive (i.e. with said mass content greater than 10%) leading to unsatisfactory electrochemical properties for a lithium-ion battery electrode, notably with a yield on the first charging-discharging cycle and a capacity at a regime of C/5 that are both insufficient for this application.

It will also be noted that this particular functionalization of the apolar aliphatic polyolefin, both with said groups which characterize it and as regards its degree of functionalization with these groups, advantageously makes it possible in a melt-route process, and unexpectedly in the light of the teaching of the abovementioned document WO-A2-2015/124 835, to couple this binder-forming apolar aliphatic polyolefin with a sacrificial polymeric phase which is, in contrast, polar (e.g. based on at least one alkene carbonate polymer) and thus incompatible with this starting apolar polyolefin.

It will also be noted that this particular functionalization of the apolar aliphatic polyolefin also makes it possible to use it as binder in a conventional liquid-route process.

Preferably preferably, said at least one modified polyolefin has a mass content of oxygen atoms inclusive between 3% and 7%.

Advantageously, said oxygenated groups CO and OH may include C═O, C—O and —OH bonds and define:
carbonyl groups preferably comprising carboxylic acid, ketone and optionally also ester functions,
aldehyde groups, and
alcohol groups.

The term “polyolefin” means in the present description, in a known manner, an aliphatic or aromatic, homopolymeric or copolymeric polymer (“copolymer” by definition including terpolymers), derived from at least one alkene and optionally also from a comonomer other than an alkene.

The term “aliphatic polyolefin” means a nonaromatic hydrocarbon-based polyolefin, which may be linear or branched, thus notably excluding polymers of an alkene oxide, of alkene carbonate and homopolymers and copolymers derived from a vinylaromatic monomer such as styrene.

It will be noted that the apolar aliphatic polyolefins usable according to the invention exclude polyolefins containing polar functions such as halogenated polyolefins, for instance polyvinylidene fluorides or chlorides (PVDF or PVDC), polyhexafluoropropylenes and polytetrafluoroethylenes (PTFE).

According to another characteristic of the invention, said apolar aliphatic polyolefin may be chosen from the group consisting of homopolymers of an aliphatic olefin, copolymers of at least two aliphatic olefins, and mixtures thereof.

Said apolar aliphatic polyolefin may be a linear or branched nonhalogenated homopolymer of an aliphatic monoolefin, of the following types:
thermoplastic, preferably chosen from polyethylenes (e.g. of low or high density, LDPE or HDPE, respectively), polypropylenes (PP), poly(1-butenes) and polymethylpentenes, or
elastomeric, preferably chosen from polyisobutylenes.

As a variant, said apolar aliphatic polyolefin may be a linear or branched nonhalogenated copolymer of two aliphatic monoolefins, of the following types:
thermoplastic, preferably chosen from ethylene-octene copolymers (e.g. under the name Elite® 5230 G, for nonlimiting purposes), ethylene-butene, propylene-butene and ethylene-butene-hexene copolymers, or
elastomeric, preferably chosen from copolymers of ethylene and of an alpha-olefin, for instance ethylene-propylene copolymers (EPM) and ethylene-propylene-diene terpolymers (EPDM). Examples that may be mentioned, for nonlimiting purposes, include EPDMs named Vistalon® 8600 (Exxon Mobil) or Nordel IP 5565 (Dow).

Advantageously, said apolar aliphatic polyolefin may have a mass content of units derived from ethylene of greater than 50%, for example being a copolymer predominantly derived from ethylene and in minor amount from 1-octene, and/or an EPDM.

It will be noted that these apolar aliphatic polyolefins, such as EPDMs or polyethylenes, have the advantage of being inexpensive notably in comparison with the HNBRs and ethylene-ethyl acrylate copolymers used in the prior art in the melt route.

According to another aspect of the invention, said at least one modified polyolefin may be the product of a controlled thermal oxidation reaction, under an atmosphere comprising oxygen at a partial pressure of oxygen of greater than 10⁴ Pa (0.1 bar) and at an oxidation temperature of between 200° C. and 300° C., of said apolar aliphatic polyolefin with the oxygen of said atmosphere, said thermal oxidation reaction being controlled such that said mass content of oxygen atoms in said at least one modified polyolefin is inclusively between 2% and 10%.

According to a first preferential embodiment of the invention, the composition is obtained via the melt route and without solvent evaporation, being the product of said thermal oxidation applied to a precursor mixture which comprises a polar sacrificial polymeric phase, said active material, said electrically conductive filler and said apolar aliphatic polyolefin so that said polar sacrificial polymeric phase and said apolar aliphatic polyolefin form two separate phases in said precursor mixture, the thermal oxidation decomposing said polar sacrificial polymeric phase and oxidizing only said apolar aliphatic polyolefin to produce via said reaction the binder bearing oxygenated groups.

It will be noted that this precursor mixture of the composition differs from the one known from the abovementioned document WO-A2-2015/124 835 in which the binder was either dispersed in the continuous sacrificial polymeric phase or cocontinuous with this phase.

It will also be noted that said polar sacrificial polymeric phase usable in this first mode preferably comprises at least one polymer of an alkene carbonate, and may be in a residual and degraded form in the composition finally obtained.

According to a second embodiment of the invention, the composition is obtained via the liquid route, being the product of said thermal oxidation applied to a precursor mixture comprising said active material, said electrically conductive filler and said apolar aliphatic polyolefin which are dissolved or dispersed in a solvent that is evaporated off prior to said thermal oxidation reaction.

According to another preferential characteristic of the invention, said polymeric binder is not crosslinked, and may consist of said at least one modified polyolefin.

According to another characteristic of the invention, the composition may comprise:
in a mass fraction of greater than 85% and preferably greater than or equal to 90%, said active material which comprises a graphite of lithium-ion battery grade when said electrode is an anode (this graphite is, for example, the artificial graphite C-Nergy® L-Series from Timcal or one from the PGPT100, PGPT200 or PGPT202 series from Targray) or, when said electrode is a cathode, an alloy of lithiated transition metal oxides preferably chosen from the group consisting of alloys of lithiated nickel, manganese and cobalt (NMC) oxides and alloys of lithiated nickel, cobalt and aluminum (NCA) oxides,
said polymeric binder in a mass fraction of less than 5%, preferably between 2% and 4%, and
said electrically conductive filler which is chosen from the group consisting of carbon blacks, notably of high purity, expanded graphites, carbon fibers, carbon nanotubes, graphenes, and mixtures thereof, in a mass fraction of between 1% and 8%, preferably between 3% and 7%.

It will be noted that this mass fraction of more than 85% of said active material in the electrode composition contributes toward giving high performance to the lithium-ion battery incorporating it.

It will also be noted that it is possible to incorporate into an electrode composition according to the invention one or more other specific additives, in order to improve or optimize its manufacturing process.

A process according to the invention for preparing an electrode composition as defined above successively comprises:
a) mixing of ingredients of the composition comprising said active material, at least one said apolar aliphatic polyolefin and said electrically conductive filler, to obtain a precursor mixture of said composition,
b) deposition in film form of said precursor mixture onto a metallic current collector, and then
c) a thermal oxidation reaction of said film under an atmosphere comprising oxygen at a partial pressure of oxygen of greater than 10⁴ Pa and at an oxidation temperature of between 200° C. and 300° C., preferably greater than 240° C. and less than 290° C. for a variable oxidation time (which may range from a few minutes to 30 minutes or more), while controlling said thermal oxidation reaction so that, in the composition obtained, said mass content of oxygen atoms in said at least one polyolefin modified with CO and OH oxygenated groups is inclusively between 2% and 10%.

It will be noted that this process according to the invention requires precise control of said reaction to obtain this particular functionalization notably characterized by this oxygen content range, representative of the minimum and maximum degrees of functionalization with these groups to be achieved, by adapting the temperature, pressure and thermal oxidation time conditions to the chosen apolar aliphatic polyolefin. Specifically, these conditions may vary considerably from one polymer to another for generating these CO and OH groups and said oxygen content.

According to said first preferential embodiment, the following may be performed:
step a) by mixing said ingredients via the melt route and without solvent evaporation, said ingredients also comprising a polar sacrificial polymeric phase which preferably comprises at least one alkene carbonate polymer and which is present in said precursor mixture in a volume fraction preferably greater than 30% and even more preferentially greater than 40%, said apolar aliphatic polyolefin and said polar sacrificial phase forming after said mixing two separate phases in said precursor mixture, and
step c) by controlled temperature increase from a starting temperature preferably between 40° C. and 60° C. to said oxidation temperature followed by an isotherm at said oxidation temperature during said oxidation time, to at least partially eliminate said polar sacrificial polymeric phase by thermal decomposition.

It will be noted that it is thus advantageously possible to dispense with any compatibilizing compound to obtain the composition of the invention, despite the incompatibility between said apolar aliphatic polyolefin and said polar sacrificial polymeric phase.

In accordance with this first embodiment, said polar sacrificial polymeric phase may advantageously comprise:
in a mass fraction in said phase of greater than 50%, a poly(alkene carbonate) polyol with a weight-average molecular mass of between 500 g/mol and 5000 g/mol, and
in a mass fraction in said phase of less than 50%, a poly(alkene carbonate) with a weight-average molecular mass of between 20 000 g/mol and 400 000 g/mol.

According to said second embodiment of the invention, the following may be performed:
step a) by liquid-route milling of said ingredients dissolved or dispersed in a solvent, and
step c) by controlled annealing of said film at said oxidation temperature, after evaporating off said solvent following step b).

In accordance with this second embodiment via the liquid route, it is also advantageously possible to use an agent for dissolving said apolar aliphatic polyolefin in the solvent notably in the case where said polyolefin is a thermoplastic ethylene homopolymer or copolymer (e.g. a polyethylene or ethylene-octene copolymer), this agent being, for example, dichlorobenzene.

An electrode according to the invention is capable of forming a lithium-ion battery anode or cathode, and it comprises:
a film which consists of a composition as defined above including said first and second embodiments and which has a thickness at least equal to 50 μm, for example between 50 μm and 100 μm, and
a metallic current collector in contact with said film.

Advantageously, the electrode may be capable of giving the lithium-ion battery incorporating it a first charging-discharging cycle yield of greater than 60%, said first charging-discharging cycle being performed at a regime of C/5 between 1 V and 10 mV for an anode and between 4.3 V and 2.5 V for a cathode.

According to said first preferential embodiment of the invention, said film consists of a composition obtained via the melt route as presented above, and the electrode may advantageously be capable of giving the lithium-ion battery incorporating it said first charging-discharging cycle yield which is greater than 75%.

In accordance with said first embodiment, the electrode may be an anode comprising a graphite of lithium-ion battery grade for said active material, and may advantageously be capable of giving the lithium-ion battery incorporating it, for cycles performed between 1 V and 10 mV:
said first charging-discharging cycle yield which is greater than 85% and preferably greater than 88%, and/or
a capacity at a regime of C/5 of greater than 250 mAh/g of electrode and preferably greater than or equal to 275 mAh/g of electrode, and/or
a degree of retention of capacity at a regime of C/5 after 20 cycles relative to the first cycle which is greater than or equal to 95% and, for example, 100%.

Also in accordance with said first embodiment, the electrode may be a cathode comprising an alloy of lithiated transition metal oxides preferably chosen from the group consisting of alloys of lithiated nickel, manganese and cobalt (NMC) oxides and alloys of lithiated nickel, cobalt and aluminum (NCA) oxides for said active material, the electrode advantageously being capable of giving the lithium-ion battery incorporating it, for cycles performed between 4.3 V and 2.5 V:
said first charging-discharging cycle yield which is greater than or equal to 77%, and/or
a capacity at a regime of C/5 of greater than 125 mAh/g of electrode, and/or
a capacity at a regime of C/2 of greater than 115 mAh/g of electrode, and/or
a degree of retention of capacity at a regime of C/2 relative to the first cycle which is greater than or equal to 95% and, for example, 100% after 20 cycles and also preferably after 40 cycles, and/or
a capacity at a regime of C of greater than 105 mAh/g of electrode.

A lithium-ion battery according to the invention comprises at least one cell including an anode, a cathode and an electrolyte based on a lithium salt and a nonaqueous solvent, and the battery is characterized in that said anode and/or said cathode each consist of an electrode as defined above.

Other characteristics, advantages and details of the present invention will emerge on reading the following description of several exemplary embodiments of the invention, which are given as nonlimiting illustrations in relation with the attached drawing, in which:

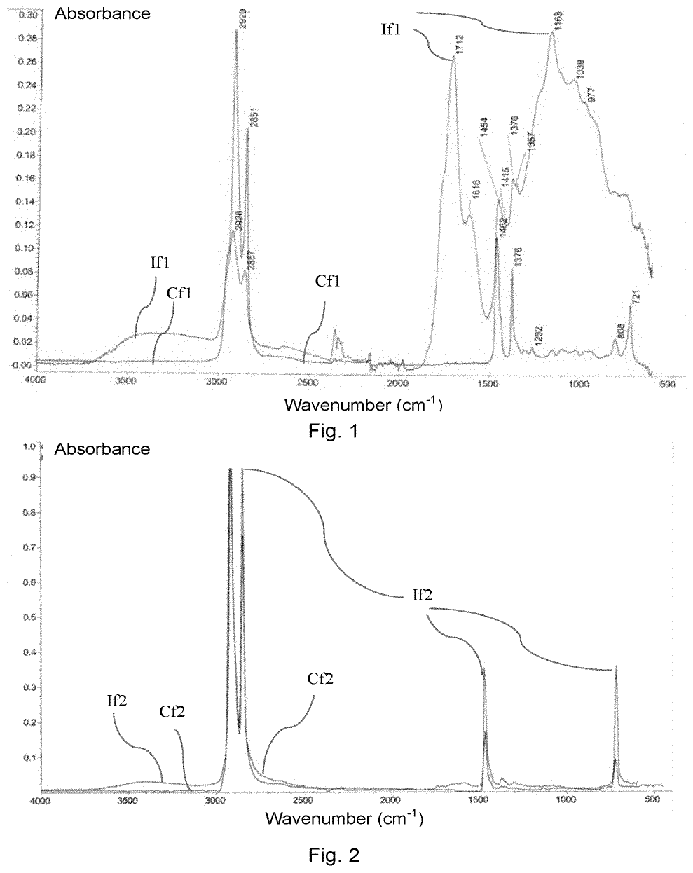

FIG. 1 is a graph illustrating the absorbance spectra measured by Fourier transform infrared spectroscopy (abbreviated to FTIR) showing the change in absorbance as a function of the wavenumber of two elastomeric films consisting of a first control binder formed from an unmodified EPDM and of a first binder according to the invention formed from the same modified EPDM, and

FIG. 2 is a graph illustrating the absorbance spectra measured by FTIR showing the change in absorbance as a function of the wavenumber of two thermoplastic films consisting of a second control binder formed from an unmodified polyethylene and of a second binder according to the invention formed from the same modified polyethylene.

### CONTROL EXAMPLE AND EXAMPLE ACCORDING TO THE INVENTION OF LITHIUM-ION BATTERY ANODES AND CATHODES PREPARED VIA LIQUID AND MELT ROUTES

In all these examples, the following ingredients were used:

a) as anode active material, an artificial graphite of lithium-ion battery grade;

b) as cathode active material, an alloy of lithiated nickel, manganese and cobalt oxides NMC 532 (Targray);

c) as conductive filler:

c1) for the anodes, a conductive purified expanded graphite,

c2) for the cathodes, a conductive carbon black named C65 (Timcal);

d) as liquid-route solvent, heptane (Aldrich);

e) as sacrificial polymeric phase for the melt-route process, a blend of two polypropylene carbonates (PPC): one being liquid and bearing diol functions, named Converge® Polyol 212-10 from Novomer, which is present in this phase in a mass fraction of 65%, and the other being solid, named QPAC® 40 from Empower Materials, which is present in this phase in a mass fraction of 35%;
f) as binder:
f0) a control binder HNBR Zetpol® 0020 (Zeon Chemicals);
f1) a terpolymer according to the invention EPDM Vistalon® 8600 (ExxonMobil) which has a mass content of ethylene of 58.0% and a content of ethylidenenorbornene (ENB) of 8.9%; or

f2) a low-density polyethylene according to the invention named Elite® 5230 G, which consists to more than 99.0% of a linear copolymer of ethylene and 1-octene (CAS registry number 26221-73-8).

Liquid-Route Protocol for Preparing Anodes C1, I1:

Two Li-ion battery anodes were manufactured, a control anode C1 and an anode according to the invention I1, by mixing the ingredients a), c1), d) and f1) in a ball mill, followed by coating the dispersion obtained after mixing onto a metal sheet forming a current collector, subsequent drying and annealing.

The active material, the conductive filler and the binder (dissolved in heptane in a 1/10 mass ratio) were first mixed in the heptane by milling in a ball mill for 3 minutes at 350 rpm.

The dispersions obtained were then coated onto a naked copper sheet 12 μm thick, using a doctor blade with an aperture of 150 μm. After evaporating off the solvent at 60° C. for 2 hours, the coated film was annealed at 250° C. for 30 minutes for the anode I1 of the invention by controlled oxidation of the film in ambient air for the purpose of modifying the EPDM binder as explained below in relation with FIG. 1, it being pointed out that the control anode C1 was obtained without this annealing. A final thickness for each of the two anodes ranging from 50 μm to 100 μm was obtained.

The anode compositions C1, I1 thus obtained each had the following formulation, expressed as mass fractions:
94% of active material a),
34% of conductive filler c1), and
3% of unmodified binder f1) for C1 and of binder f1) modified according to the invention for I1.

Melt-Route Protocol for Preparing Anodes C2, I2, I3 and Cathodes I4, I5, I4′:

The melt route was used to prepare three anodes based on the ingredients a), c1), e) and f0), f1) or f2), and two cathodes based on the ingredients b), c2), e) and f1) or f2), in both cases using a Haake Polylab OS internal mixer with a volume of 69 cm³ and at a temperature of between 60° C. and 75° C.

The mixtures thus obtained were calendered at room temperature using a Scamex external roll mill to achieve a film thickness of 200 μm, and they were then calendered again at 50° C. to achieve a thickness of 50 μm. The films obtained were deposited on a copper collector using a sheet calender at 70° C.

The anode and cathode precursor films were placed in an oven in order to extract therefrom the sacrificial phase (solid and liquid PPC). They were subjected to a controlled temperature ramp from 50° C. to 250° C. and then an isotherm of 30 minutes at 250° C. while subjecting them to thermal oxidation in ambient air, to decompose this sacrificial phase and to functionalize the corresponding binder f0), f1) or f2).

Three anode compositions were thus obtained consisting of a control composition C2 and of two compositions according to the invention I2 and I3 from a precursor mixture comprising 42% by volume of the sacrificial phase e), with microscopic detection in this precursor mixture of two separate phases based, respectively, on the binder and the sacrificial phase. These three anode compositions C2, I2, I3 each had the following final formulation after elimination of this sacrificial phase, expressed as mass fractions:
94% of active material a),
3% of conductive filler c1), and
3% of modified binder f0) not in accordance with the invention for C2, of modified binder f1) according to the invention for I2 and of modified binder f2) according to the invention for I3.

This melt-route protocol was also used to obtain two cathode compositions according to the invention I4 and I5 from a precursor mixture comprising 50% by volume of the same sacrificial phase e) (blending of two solid and liquid PPCs), with microscopic detection in this precursor mixture of two separate phases based, respectively, on the binder and the sacrificial phase. These two compositions I4 and I5 each had the following formulation after elimination of this sacrificial phase, expressed as mass fractions:
90% of active material b),
7% of conductive filler c2), and
3% of modified binder f1) according to the invention for I4 and of modified binder f2) according to the invention for I5.

This same melt-route protocol was also used to obtain another cathode I4′ which differs from the cathode I4 only in that its final thickness was 80 μm instead of the 50 μm obtained for I4. The composition of the cathode I4′ was thus obtained from the same precursor mixture as for 14 and had the same formulation as that of I4 after elimination of the same sacrificial phase e).

Characterization of the Binders If1 and If2 According to the Invention:

The unmodified binders f1) and f2) and the modified binders If1 and If2 according to the invention were characterized during the abovementioned liquid route and melt route processes, via the FTIR (Fourier transform infrared spectroscopy) technique, giving absorbance spectra as a function of the wavenumber.

To this end, five first films Cf1 100 μm thick each formed from the binder f1) consisting of the EPDM Vistalon® 8600, and five second films Cf2 100 μm thick each formed from the binder f2) consisting of the polyethylene Elite® 5230 G, were deposited on copper, by evaporation of a solution in heptane. Each of the first and second films Cf1 and Cf2 thus deposited were then treated in a controlled manner for 30 minutes at 250° C. in ambient air, so as to obtain the CO and OH groups modifying these binders f1) and f2) in accordance with the invention. Each of the films Cf1, If1, Cf2, If2 was then studied by FTIR in “ATR” (attenuated total reflectance) mode.

FIG. 1 shows the spectrum for the EPDM Vistalon® 8600 of one of the five first films Cf1 not yet heat-treated (Cf1 incorporating the unmodified binder f1)) and the spectrum for the same EPDM of this first film If1 but treated at 250° C. for 30 minutes as indicated above, and it is seen that this last spectrum shows bands characteristic of the thermal oxidation of the EPDM such as C═O bonds at 1712 cm⁻¹, C—O bonds at 1163 cm⁻¹ and —OH bonds at 3400 cm⁻¹. The mass content of oxygen atoms in each of the five first films If1 of this EPDM thus modified was measured by elemental analysis, and a mean value of 5.9% with a standard deviation of 0.29% was found for this content for the five measurements performed.

FIG. 2 shows the spectrum for the polyethylene Elite® 5230 G of one of the five second films Cf2 not yet heat-treated (Cf2 incorporating the unmodified binder f2)) and the spectrum for the same polyethylene of this second film If2 but treated at 250° C. for 30 minutes as indicated above, and it is seen that this last spectrum shows bands characteristic of the thermal oxidation of the polyethylene such as the C═O, C—O and —OH bonds at the abovementioned wavenumbers. The mass content of oxygen atoms in each of the five second films If2 of this polyethylene thus modified was measured by elemental analysis, and a mean value of 4.5% with a standard deviation of 0.65% was found for this content for the five measurements performed.

Protocol for Electrochemical Characterization of the Anodes C1 and 11 Prepared Via the Liquid Route, of the Anodes C2 and 12, I3 Prepared Via the Melt Route and of the Cathodes I4, I5, I4′ Prepared Via the Melt Route:

The anodes C1, C2, I1, I2, I3 and the cathodes I4, I5, I4′ were cut out using a sample punch (diameter 16 mm, area 2.01 cm²) and were weighed. The mass of active material was determined by subtracting the mass of the naked current collector prepared under the same conditions (heat treatments). They were placed in a furnace directly connected to a glovebox. They were dried at 100° C. under vacuum for 12 hours and were then transferred into the glovebox (argon atmosphere: 0.1 ppm H₂O and 0.1 ppm O₂).

The button cells (CR1620 format) were then assembled using a lithium metal counterelectrode, a Cellgard 2500 separator and an LiPF6 EC/DMC battery-grade electrolyte (50%/50% mass ratio). The cells were characterized on a Biologic VMP3 potentiostat, by performing:
to test the anodes, charging/discharging cycles at a constant current between 1 V and 10 mV at a regime of C/5 and considering the mass of active material and a theoretical capacity of 372 mAh/g, and
to test the cathodes, charging/discharging cycles at a constant current between 4.3 V and 2.5 V at a regime of C/5 and considering the mass of active material and a theoretical capacity of 170 mAh/g.

In order to compare the performance of the various systems, the capacities (expressed in mAh per g of anode or of cathode) were evaluated during the first discharging for the deinsertion of lithium (i.e. initial capacity after the first charging-discharging cycle), on the second discharge (measurement of the yield of the first cycle), after 20 cycles for the anodes and cathodes and after 40 cycles for the cathodes, to calculate the degree of retention (in %) defined by the ratio of the capacity at 20 or 40 cycles to the capacity at the first cycle at the same given regime (C/5). Besides the capacities at a regime of C/5 for the anodes and cathodes, the capacities at regimes of C/2, C, 2C and 5C were measured for the cathodes (all these capacities being expressed in mAh per g of electrode).

Table 1 below gives the results of this characterization for the anodes C1, I1, C2, I2, I3 and the cathodes I4, I5 in each cell thus obtained.

TABLE 1

| | | | | | | |
|---|---|---|---|---|---|---|
| | Capacity | Capacity | Capacity | Capacity | Capacity | Capacity |
| | 1^{st} cycle | 20^{th} cycle | 1^{st} cycle | 1^{st} cycle | 1^{st} cycle | 1^{st} cycle |
| Yield 1^{st} | at C/5 | at C/5 | at C/2 | at C | at 2C | at 5C |
| cycle | (mAh/g) | (mAh/g) | (mAh/g) | (mAh/g) | (mAh/g) | (mAh/g) |

Liquid route anodes

| | | |
|---|---|---|
| C1 | 36% | 57 |
| I1 | 62% | 185 |

Melt route anodes

| | | | |
|---|---|---|---|
| C2 | 85% | 290 | 290 |
| I2 | 90% | 290 | 290 |
| I3 | 89% | 275 | 275 |

Melt route cathodes

| | | | | | |
|---|---|---|---|---|---|
| I4 | 78% | 119 | 108 | 78 | 8 |
| I5 | 79% | 121 | 107 | 78 | 18 |

Table 1 shows a marked improvement (more than 70%) in the yield at the first cycle and an even greater improvement (of more than 220%) in the capacity at C/5 of the cell whose anode I1 obtained via the liquid route comprised as binder an EPDM modified by controlled thermal oxidation (modified with oxygenated groups containing C═O, C—O and —OH bonds and a mass content of oxygen of between 5% and 6%), relative to this same yield of a control cell whose anode C1 obtained via the liquid route comprised as binder the same EPDM but not modified.

Table 1 also shows an improvement (of about 5%) in the yield at the first cycle of the cells whose anodes I2 and I3 obtained via the melt route comprised as binder an EPDM or a polyethylene modified by controlled thermal oxidation (modified with oxygenated groups containing C═O, C—O and —OH bonds and a mass content of oxygen of between 4% and 6%), relative to this same yield of a control cell whose anode C2 obtained via the melt route comprised as binder an HNBR modified by the same thermal oxidation treatment, and without penalizing the cyclability of the anodes I2 and I3 relative to the anode C1 (see the degree of retention of capacity at C/5 which is conserved at 100% between the 20^{th} cycle and the 1^{st} cycle).

Table 1 also shows that the cathodes I4 and 15 obtained via the melt route with EPDM and polyethylene binders, respectively, each modified by this same controlled thermal oxidation, gave the cells incorporating them similar, satisfactory capacities at C/2, C, 2C and 5C.

As regards the only cathode I4′ with a thickness equal to 80 μm prepared via the melt route, the capacities that it gave to the corresponding cell were measured at regimes of C/5 and C/2 (at the first cycle, after 20 cycles and after 40 cycles), as may be seen in table 2 below.

TABLE 2

| | Capacity 1^{st} | Capacity 1^{st} | Capacity 20^{th} | Capacity 40^{th} |
|---|---|---|---|---|
| | cycle at C/5 | cycle at C/2 | cycle at C/2 | cycle at C/2 |
| | (mAh/g) | (mAh/g) | (mAh/g) | (mAh/g) |
| I4′ | 130 | 122 | 122 | 122 |

Table 2 shows that the cathode I4′ obtained via the melt route with the EPDM binder modified by this same controlled thermal oxidation also gave the cell incorporating it satisfactory capacities at C/5 and C/2, in particular with a very satisfactory cyclability after 20 and even 40 cycles (see the degree of retention of capacity at C/2 after 20 and 40 cycles, which is 100%).

1. A composition comprising:
an active material for performing reversible insertion/deinsertion of lithium in an electrode,
an electrically conductive filler and
a polymeric binder comprising a modified polyolefin, wherein the modified polyolefin is derived from an apolar aliphatic polyolefin and incorporates CO and OH oxygenated groups, the modified polyolefin having a mass content of oxygen atoms inclusively between 2% and 10%, and
the composition is an electrode composition for a lithium-ion battery.

2. The composition of claim 1, wherein the modified polyolefin has a mass content of oxygen atoms inclusively between 3% and 7%.

3. The composition of claim 1, wherein the CO and OH oxygenated groups comprise C═O, C—O and —OH bonds defining:
carbonyl groups,
aldehyde groups, and
alcohol groups.

4. The composition of claim 1, wherein the apolar aliphatic polyolefin is at least one selected from the group consisting of a homopolymer of an aliphatic olefin and a copolymer of at least two aliphatic olefins.

5. The composition of claim 4, wherein the apolar aliphatic polyolefin is a linear or branched nonhalogenated thermoplastic or elastomeric homopolymer of an aliphatic monoolefin.

6. The composition of claim 4, wherein the apolar aliphatic polyolefin is a linear or branched nonhalogenated thermoplastic or elastomeric copolymer of two aliphatic monoolefins.

7. The composition of claim 5, wherein the apolar aliphatic polyolefin has a mass content of units derived from ethylene of greater than 50%.

8. The composition of claim 1, wherein the modified polyolefin is a product of a thermal oxidation reaction, under an atmosphere comprising oxygen at a partial pressure of oxygen of greater than 10⁴ Pa and at an oxidation temperature of between 200° C. and 300° C., of the apolar aliphatic polyolefin with the oxygen of the atmosphere, the thermal oxidation reaction being controlled such that the mass content of oxygen atoms in the modified polyolefin is inclusively between 2% and 10%.

9. The composition of claim 8, wherein the composition is obtained via a melt route and without solvent evaporation, being a product of the thermal oxidation applied to a precursor mixture which comprises a polar sacrificial polymeric phase, the active material, the electrically conductive filler and the apolar aliphatic polyolefin so that the polar sacrificial polymeric phase and the apolar aliphatic polyolefin form two separate phases in the precursor mixture, the thermal oxidation decomposing the polar sacrificial polymeric phase.

10. The composition of claim 8, wherein the composition is obtained via a liquid route, being a product of the thermal oxidation applied to a precursor mixture comprising the active material, the electrically conductive filler and the apolar aliphatic polyolefin which are dissolved or dispersed in a solvent that is evaporated off prior to the thermal oxidation.

11. The composition of claim 1, wherein the polymeric binder is not crosslinked and consists of the modified polyolefin.

12. The composition of claim 1, wherein the composition comprises:
in a mass fraction of greater than 85%, the active material which comprises a graphite of lithium-ion battery grade when the electrode is an anode or, when the electrode is a cathode, an alloy of lithiated transition metal oxides selected from the group consisting of an alloy of lithiated nickel, manganese and cobalt (NMC) oxides and an alloy of lithiated nickel, cobalt and aluminum (NCA) oxides,
the polymeric binder in a mass fraction of less than 5%, and
the electrically conductive filler which is at least one selected from the group consisting of a carbon black, an expanded graphite, a carbon fiber, a carbon nanotube, and a graphene, in a mass fraction of between 1% and 8%.

13. An electrode, comprising:
a film which consists of the composition of claim 1 and which has a thickness at least equal to 50 μm, and
a metallic current collector in contact with the film,
wherein the electrode is an electrode for forming a lithium-ion battery anode or cathode.

14. The electrode of claim 13, wherein the electrode is capable of giving the lithium-ion battery incorporating it a first charging-discharging cycle yield of greater than 60%, the first charging-discharging cycle being performed at a regime of C/5 between 1 V and 10 mV for the anode and between 4.3 V and 2.5 V for the cathode.

15. The electrode of claim 14, wherein the film consists of a composition obtained via a melt route and without solvent evaporation, the composition being a product of a thermal oxidation reaction applied to a precursor mixture which comprises a polar sacrificial polymeric phase, the active material, the electrically conductive filler and the apolar aliphatic polyolefin so that the polar sacrificial polymeric phase and the apolar aliphatic polyolefin form two separate phases in the precursor mixture, the thermal oxidation decomposing the polar sacrificial polymeric phase,
wherein the modified polyolefin is a product of the thermal oxidation reaction, under an atmosphere comprising oxygen at a partial pressure of oxygen of greater than 10⁴ Pa and at an oxidation temperature of between 200° C. and 300° C., of the apolar aliphatic polyolefin with the oxygen of the atmosphere, the thermal oxidation reaction being controlled such that the mass content of oxygen atoms in the modified polyolefin is inclusively between 2% and 10%, and
wherein the electrode is capable of giving the lithium-ion battery incorporating it the first charging-discharging cycle yield which is greater than 75%.

16. The electrode of claim 15, wherein the electrode is an anode comprising a graphite of lithium-ion battery grade for the active material, and is capable of giving the lithium-ion battery incorporating it, for cycles performed between 1 V and 10 mV:
the first charging-discharging cycle yield which is greater than 85%,
a capacity at a regime of C/5 of greater than 250 mAh/g of the electrode, or
a degree of retention of capacity at a regime of C/5 after 20 cycles relative to the first charging-discharging cycle which is greater than or equal to 95%.

17. The electrode of claim 15, wherein the electrode is a cathode comprising an alloy of lithiated transition metal oxides selected from the group consisting of an alloy of lithiated nickel, manganese and cobalt (NMC) oxides and an alloy of lithiated nickel, cobalt and aluminum (NCA) oxides for the active material, the electrode being capable of giving the lithium-ion battery incorporating it, for cycles performed between 4.3 V and 2.5 V:
the first charging-discharging cycle yield which is greater than or equal to 77%,
a capacity at a regime of C/5 of greater than 125 mAh/g of the electrode,
a capacity at a regime of C/2 of greater than 115 mAh/g of the electrode,
a degree of retention of capacity at C/2 relative to the first charging-discharging cycle which is greater than or equal to 95% after 20 cycles, or
a capacity at a regime of C of greater than 105 mAh/g of the electrode.

18. A lithium-ion battery, comprising a cell comprising an anode, a cathode and an electrolyte based on a lithium salt and a nonaqueous solvent, wherein the anode and/or the cathode each consist of the electrode of claim 13.

19. A process for preparing the composition of claim 1, wherein the process successively comprises:
a) mixing of ingredients of the composition comprising the active material, the apolar aliphatic polyolefin and the electrically conductive filler, to obtain a precursor mixture of the composition,
b) depositing a film form of the precursor mixture onto a metallic current collector, and
c) carrying out a thermal oxidation reaction of the film under an atmosphere comprising oxygen at a partial pressure of oxygen of greater than 10⁴ Pa and at an oxidation temperature of between 200° C. and 300° C. while controlling the thermal oxidation reaction so that, in the composition obtained, the mass content of oxygen atoms in the modified polyolefin modified with the CO and OH oxygenated groups is inclusively between 2% and 10%.

20. The process of claim 19, comprising:
step a) by liquid-route milling of the ingredients dissolved or dispersed in a solvent, and
step c) by controlled annealing of the film at the oxidation temperature, after evaporating off the solvent following step b).

21. The process of claim 19, comprising:
step a) by mixing the ingredients via a melt route and without solvent evaporation, the ingredients also comprising a polar sacrificial polymeric phase which is present in the precursor mixture in a volume fraction greater than 30%, the apolar aliphatic polyolefin and the polar sacrificial phase forming after the mixing two separate phases in the precursor mixture, and
step c) by controlled temperature increase from a starting temperature to the oxidation temperature followed by an isotherm at the oxidation temperature, to at least partially eliminate the polar sacrificial polymeric phase by thermal decomposition.

22. The process of claim 21, wherein the polar sacrificial polymeric phase comprises:
in a mass fraction in the phase of greater than 50%, a poly(alkene carbonate) polyol with a weight-average molecular mass of between 500 g/mol and 5000 g/mol, and
in a mass fraction in the phase of less than 50%, a poly(alkene carbonate) with a weight-average molecular mass of between 20 000 g/mol and 400 000 g/mol.

23. The composition of claim 5, wherein the apolar aliphatic polyolefin is
a thermoplastic homopolymer selected from a polyethylene, a polypropylene, poly(l-butenes) and a polymethylpentene, or
an elastomeric homopolymer, which is a polyisobutylene.

24. The composition of claim 6, wherein the apolar aliphatic polyolefin is
a thermoplastic copolymer selected from an ethylene-octene copolymer, an ethylene-butene copolymer, a propylene-butene copolymer and an ethylene-butene-hexene copolymers, or
an elastomeric copolymer, which is a copolymer of ethylene and an alpha-olefin.

25. The composition of claim 7, wherein the apolar aliphatic polyolefin is a copolymer of ethylene and 1-octene, and/or an EPDM.

26. The process of claim 19, wherein in step c) the thermal oxidation reaction is carried out at an oxidation temperature greater than 240° C. and less than 290° C.

27. The process of claim 21, wherein
in step a), the polar sacrificial polymeric phase comprises at least one alkene carbonate polymer, and
in step c), the controlled temperature increase is from the starting temperature of between 40° C. and 60° C.

28. The composition of claim 6, wherein the apolar aliphatic polyolefin has a mass content of units derived from ethylene of greater than 50%.
